(19) United States
(12) Patent Application Publication
(10) Pub. No.: US 2007/0274365 A1
(43) Pub. Date: Nov. 29, 2007

(54) Periodically complex resonant structures

(75) Inventors: Jonathan Gorrell, Gainesville, FL (US); Michael E. Maines, Gainesville, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/441,240

(22) Filed: May 26, 2006

(51) Int. Cl. H01S 3/08

(52) U.S. Cl. 372/96

(57) ABSTRACT

A method includes, for each desired wavelength of a plurality of desired output wavelengths, selecting a light-emitting resonant structure (LERS) that emits light at the desired wavelength when exposed to a beam of charged particles; and forming the periodically complex resonant structure from the selected light-emitting resonant structures.

### CROSS-REFERENCE TO RELATED APPLICATIONS

The present invention is related to the following co-pending U.S. patent applications which are all commonly owned with the present application, the entire contents of each of which are incorporated herein by reference:
(1) U.S. patent application Ser. No. 11/238,991, filed Sep. 30, 2005, entitled “Ultra-Small Resonating Charged Particle Beam Modulator”;
(2) U.S. patent application Ser. No. 10/917,511, filed on Aug. 13, 2004, entitled “Patterning Thin Metal Film by Dry Reactive Ion Etching”;
(3) U.S. application Ser. No. 11/203,407, filed on Aug. 15, 2005, entitled “Method Of Patterning Ultra-Small Structures”;
(4) U.S. application Ser. No. 11/243,476, filed on Oct. 5, 2005, entitled “Structures And Methods For Coupling Energy From An Electromagnetic Wave”;
(5) U.S. application Ser. No. 11/243,477, filed on Oct. 5, 2005, entitled “Electron beam induced resonance,”
(6) U.S. application Ser. No. 11/325,448, entitled “Selectable Frequency Light Emitter from Single Metal Layer,” filed Jan. 5, 2006;
(7) U.S. application Ser. No. 11/325,432, entitled, “Matrix Array Display,” filed Jan. 5, 2006;
(8) U.S. application Ser. No. 11/410,924, entitled, “Selectable Frequency EMR Emitter,” filed Apr. 26, 2006;
(9) U.S. patent application Ser. No. 11/400,280, titled “Micro Resonant Detector for Optical Signals on a Chip,” filed Apr. 10, 2006;
(10) U.S. application Ser. No. 11/350,812, entitled “Conductive Polymers for Electroplating,” filed Feb. 10, 2006.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This relates to ultra-small resonant structures, and, more particularly, to designing periodically complex resonant structures.

### BRIEF DESCRIPTION OF THE DRAWINGS

The following description, given with respect to the attached drawings, may be better understood with reference to the non-limiting examples of the drawings, wherein:

FIG. 1 shows an ultra-small resonant structure;

FIG. 2 is a graph of intensity versus output radiation frequency;

FIG. 3 is a graph showing example intensity and wavelength versus finger length;

FIG. 4 is a graph showing intensity versus post length for a series of comb teeth;

FIG. 5 shows a periodically complex resonant structure;

FIGS. 6-7 are graphs showing exemplary output of periodically complex resonant structures;

FIG. 8 shows a voltage controlled oscillator based on periodically complex resonant structures.

### THE PRESENTLY PREFERRED EXEMPLARY EMBODIMENTS

### Background & Introduction

The related applications describe various ultra-small resonant structures (URSs) and devices formed therefrom. As described in the related applications, the ultra-small resonant structures may emit electromagnetic radiation (EMR) at a wide range of frequencies (e.g., visible light), and often at a frequency higher than that of microwave. EMR is emitted from the resonant structure when the resonant structure is exposed to a beam of charged particles ejected from or emitted by a source of charged particles. The source may be controlled, e.g., by applying a signal on a data input. The source can be any desired source of charged particles such as an ion gun, a thermionic filament, tungsten filament, a cathode, a vacuum triode, a planar vacuum triode, an electron-impact ionizer, a laser ionizer, a field emission cathode, a chemical ionizer, a thermal ionizer, an ion-impact ionizer, an electron source from a scanning electron microscope, etc. The particles may be positive ions, negative ions, electrons, and protons and the like. For the remainder of this description, and only by way of example, it will be assumed that the charged particles are electrons.

Known hermetic sealing techniques can be employed to ensure the vacuum condition remains during a reasonable lifespan of operation.

The inventors have found that photon emission from a resonant structure can be had in a beam velocity-dependent mode. If the beam voltage is denoted V, then the beam velocity, v is given by the following equation:

$$v = \sqrt{\frac{2 eV}{m}} ,$$

(where m is mass of the charged particle, and e is the charge of the particle).

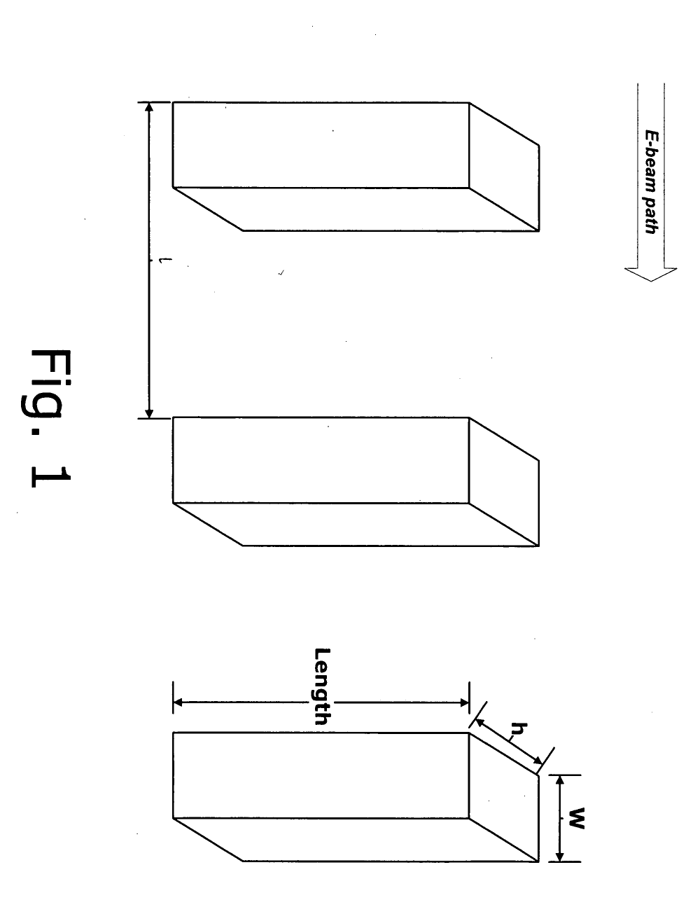

Since the beam velocity-dependent mode of the resonant structures is set from the beam interaction from device to device, an array of resonant structures with period l (as shown in FIG. 1) is constructed. The amount of emitted photons will increase with the increase of constructed periods.

That mode is also the most simple to predict. The fundamental output wavelength (λ) of this structure is given by the equation 1 (below):

$$λ = \frac{l}{\vert n \vert} [ \frac{1}{β} - sin θ ] \qquad Equation 1$$

where
l is the period of the structures,
β=v/c,
c is the speed of light,
n is the mode number, and
θ is the angle of observation (typically, though not necessarily, 90°).

Depending on the dimensional make up of the individual structures, energy may be put into the other geometrically dependent resonant modes. Depending on the excited mode, it may or may not be the dominant mode of output, but is still present. Also, depending on the application, efforts can/should be made to hinder these modes, forcing the energy into the beneficial mode.

An example of this is observed when the devices are placed very close together, thus placing the velocity dependent mode out of the visible range. This moves dominance from the velocity-dependent mode to the length-dependent mode. Within this setup, the dominating wavelength is adjusted by changing the structure's length. Likewise, once the range of dominance is surpassed on the length, the output may be dominated by the height dimension. This is similar to most modally resonant systems.

### EXAMPLE

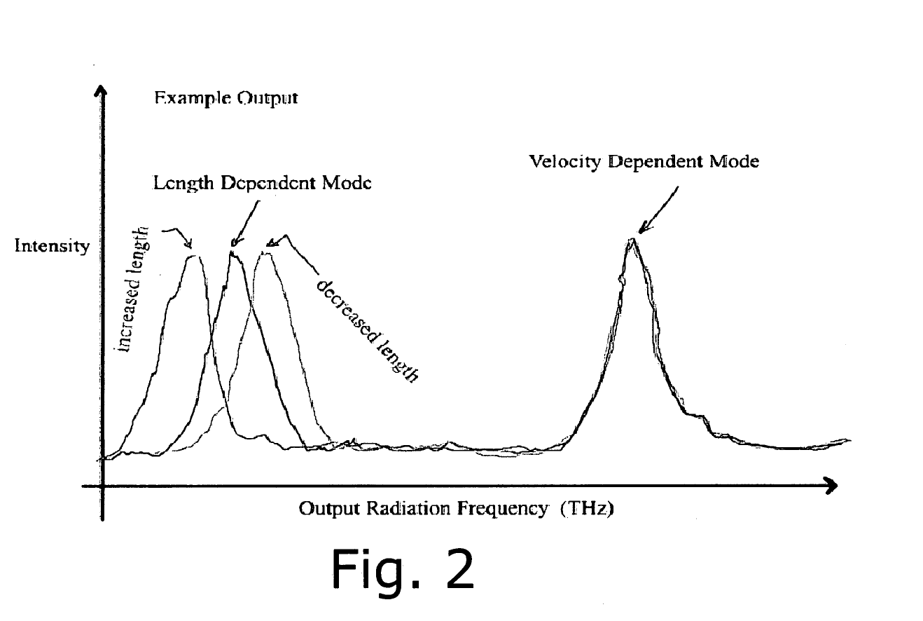

A structure was designed to allow the velocity dependent mode to remain fixed while also allowing the length dependent mode to be excited. As the structure's length was increased, the output wavelength of this mode also increased. The velocity-dependent mode, however, remained constant, as did the non-excited or non-dominant modes of height and thickness. (See FIG. 2.)

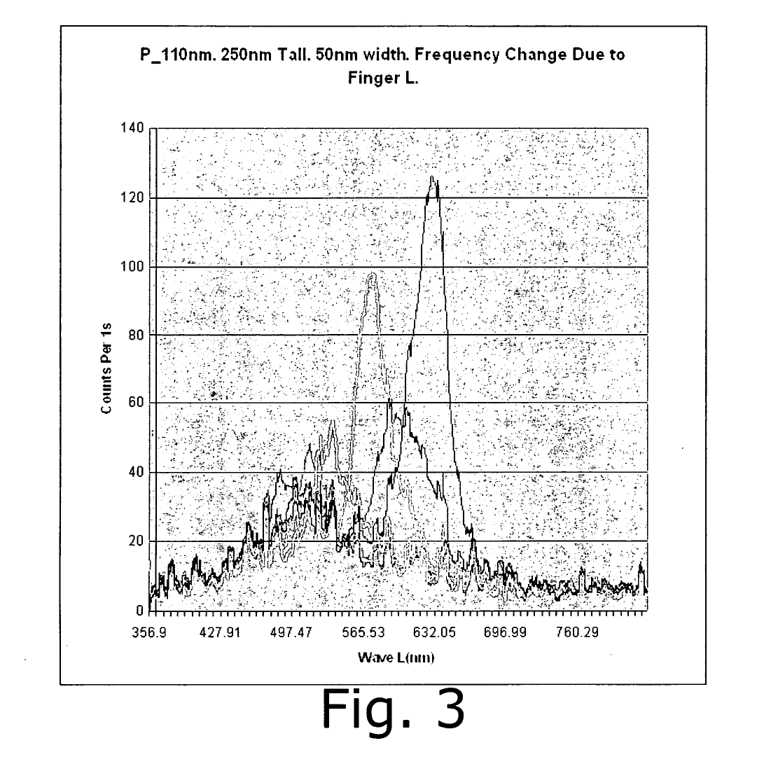

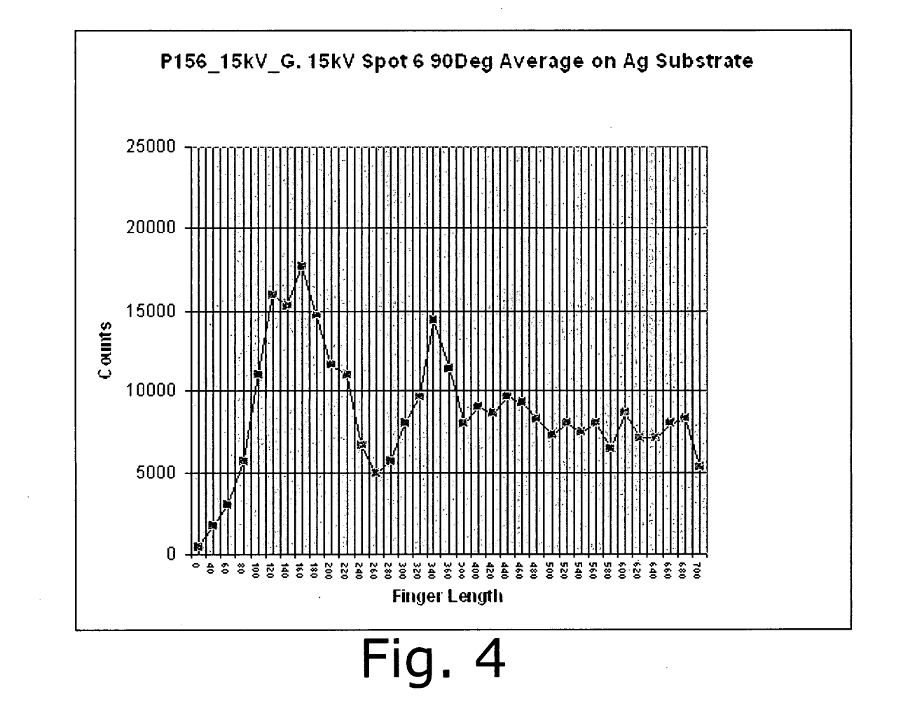

FIG. 3 (FIG. 13 from U.S. application Ser. No. 11/243,477—the '477 application—described in greater detail above, and incorporated herein by reference) is a graph showing an example of intensity and wavelength versus finger length for some of the series of comb teeth of FIG. 10 of related '477 application. As shown in FIG. 3, the frequency of the electromagnetic wave produced by the system on a row of 220 nm fingers (posts) has a recorded intensity and wavelength greater than at the lesser shown finger lengths. As described in the '477 application, one can also find the point of maximum Q for given posts (as shown in FIG. 4 (FIG. 14 from the '477 application), which is a graph showing intensity versus post length for the series of comb teeth of FIG. 10 of the '477 application).

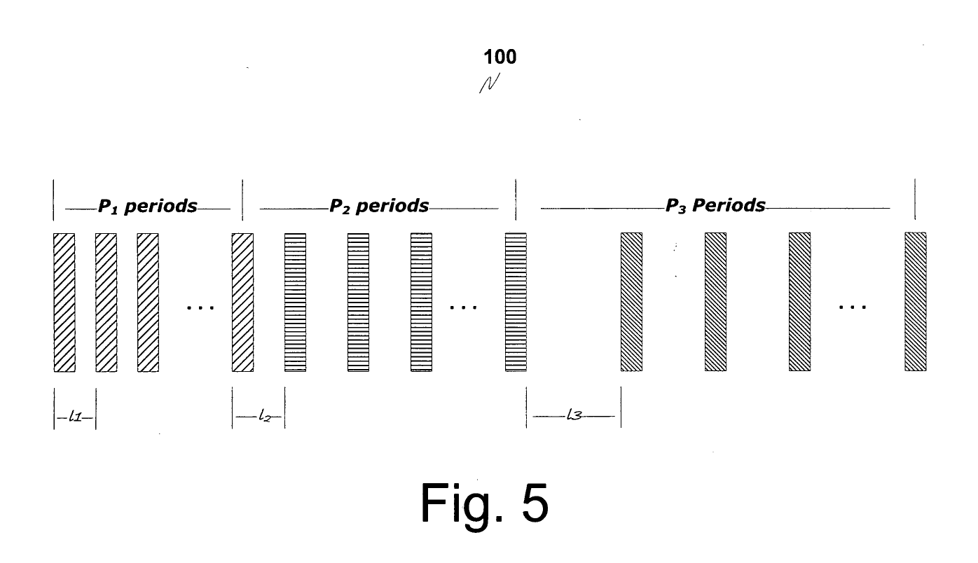

FIG. 5 shows a periodically complex resonant structure (PCRS) 100 made up of a plurality of light emitting resonant structures (LERS), where each single LERS has a different resonant period. A beam of charged particles (not shown) is used to excite the array of LERS. The individual LERS have been shaded differently in the drawing to distinguish them more clearly.

The LERS may be grouped (as shown) into arrays of one or more LERS the same resonant period. Thus, as shown, the PCRS 100 is made up, in this example, by three arrays of LERS.

In the following, the subscript depicts the LERS array number.
nᵢ=mode number for i-th PCRS
θᵢ is angle of observation for the i-th PCRS (typically—though not necessarily—90° for all PCRS)
lᵢ is the period length for the i-th LERS.
Pᵢ is the number of periods for the i-th LERS.

Thus, based on the individual equations for each LERS (see equation 1 above) as the beam excites it, the output for the i-th LERS is:

$${λ}_{i} = \frac{{l}_{i}}{\vert {n}_{i} \vert} [ \frac{1}{β} - sin {θ}_{i} ]$$

So, for the example PCRS of FIG. 5, the combined output is given by the following wavelength array (note that generally the angles of observation, θᵢ can be the same).

$${λ}_{1} = \frac{{l}_{1}}{\vert {n}_{1} \vert} [ \frac{1}{β} - sin {θ}_{1} ]$$

$${λ}_{2} = \frac{{l}_{2}}{\vert {n}_{2} \vert} [ \frac{1}{β} - sin {θ}_{2} ]$$

$${λ}_{3} = \frac{{l}_{3}}{\vert {n}_{3} \vert} [ \frac{1}{β} - sin {θ}_{3} ]$$

Those skilled in the art will realize and understand, upon reading this description and the related applications, that this enables us to generate multiple wavelengths using a single PCRS device, and a single charged particle emitter.

The geometry as well as the number of periods (Pᵢ) from LERS to LERS may be altered in order to optimize the output of the PCRS for whatever the application requires.

Those skilled in the art will realize and understand, upon reading this description, that the example of using three LERS to make-up a PCRS, was arbitrary and exemplary, and does not limit the design of the PCRS. If N different LERS are used to construct a PCRS, N different primary outputs will be available.

Using the techniques described, an array can be made such that the output array would have the following properties:

λ[n]=[λ₁,λ_{2,}λ₃, . . . λₙ],

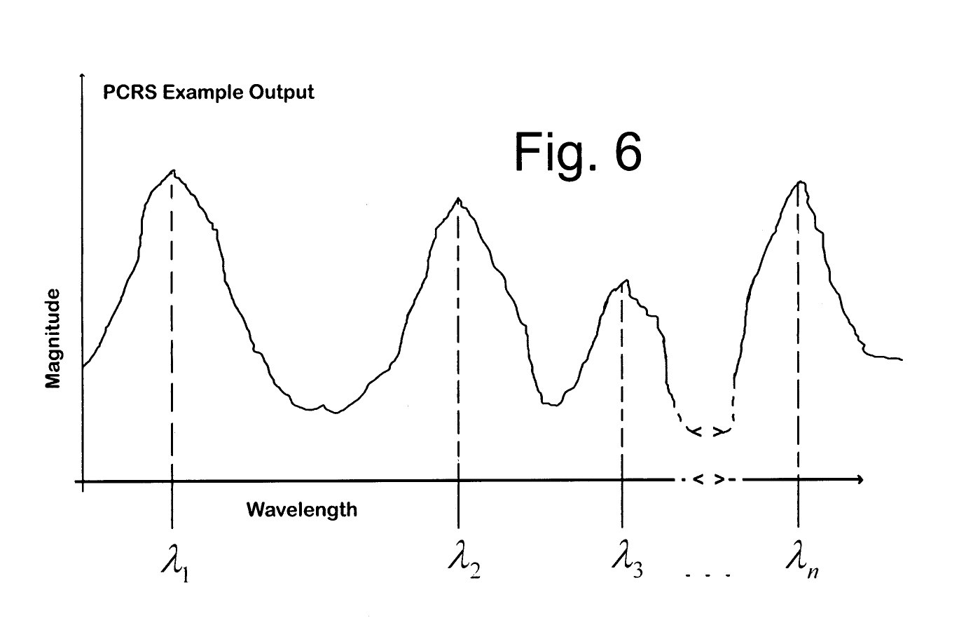

as shown in FIG. 6.

Note that for each LERS, more than one mode may be excited, thus giving way to even more options for output.

Those skilled in the art will realize and understand, upon reading this description, that the fact of producing multiple and diverse radiations out of a single device and exciter, allows for the design of complex LERS systems as well as improvements for singular operation of the LERS.

### Example 1

A PCRS is designed, centered around a single (or group of) LERS that has an output wavelength of λ_{f} which corresponds to a period of l_{f}. If a few LERS with periods, l_{f}±Δl, are added where Δl depicts the slight change in period, the output array would be,

λ[n]=[λₗ_{_{f}}_{-Δl}, λ_{f}, λₗ_{_{f}}_{+Δl]}

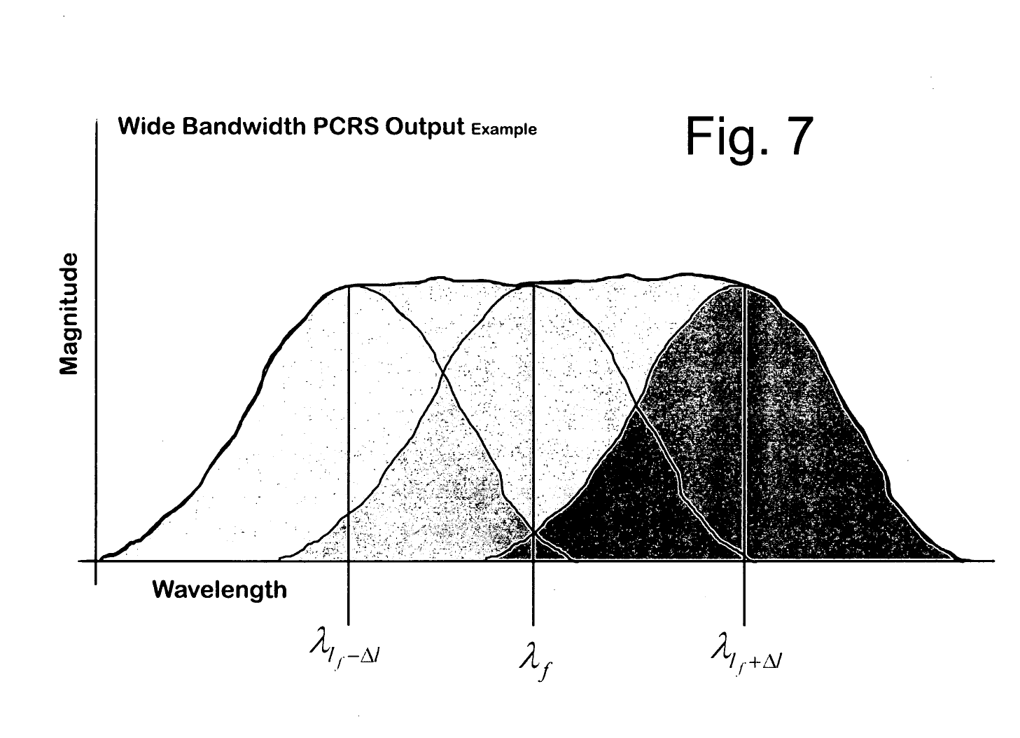

if Δl is chosen in such a way as to not be too large, where the delineation of too large depends on the bandwidth of the initial l_{f} device, the curve of each output will overlap and create a PCRS which has a larger bandwidth than that of the single LERS, as shown in FIG. 7.

### Example 2

### A PCRS-Based Voltage Controlled Oscillator (VCO)

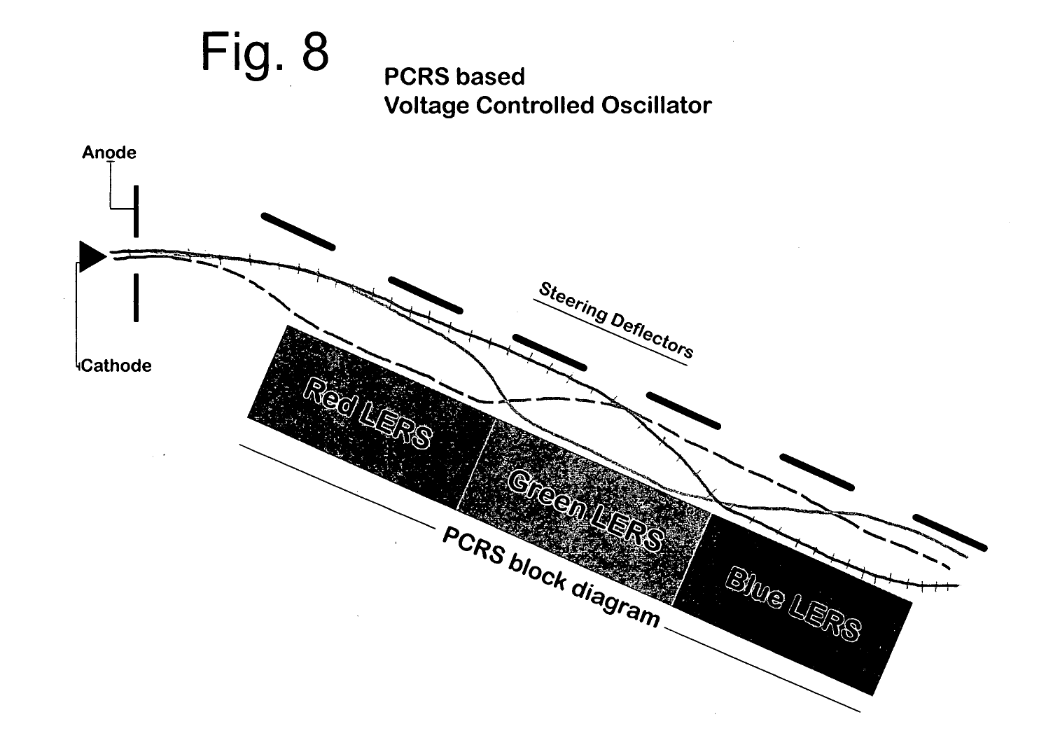

Referring to FIG. 8, a PCRS is designed to contain a variety of wavelengths (again, represented by shaded groupings). This array of wavelengths could have an infinite number of configurations and would be application dependent. For the purpose of example; red, green, and blue are used, though some or all of the frequencies could be in a non-visible spectrum.

The charged particle emitter and anode initially set the particle in motion in a direction toward a specific steering deflector. The specific steering deflector is chosen by the user as it is an input voltage to the anode that directs the charged particle beam to the appropriate steering deflector. The steering deflectors are shown more simply than in a practical design, as they would be made and biased in such a way as to optimize the beam's interaction with the PCRS. The red, green, and blue, lines from the emitter show possible scenarios for creating the respective output, the beam deflection is exaggerated and the figure is by no means to scale.

As can be seen from FIG. 8, based on the user set input voltage, the beam will be directed to the appropriate LERS to be excited. By allowing an input to the steering deflectors, even more control on the output is given. Now, any combination of the LERS may be excited, as they would be essentially “mixed” based on the deflection of the steering deflectors. This makes the above device very versatile.

### Example 3

### Multicolor Light Generation

Those skilled in the art will realize and understand, upon reading this description, that a LERS can be used to generate multi-colored light, using a different combination of the component parts.

### Applications

The PCRS may also be used as a switch. The voltages driving the steering deflectors would be more to the extremes, making that particular LERS on or off. Suppose a three-bit word is desired, simply allow three colors to represent bits, where on=1, off=0. It is easily seen that a whole three-bit word can be made from one device and one beam. Those skilled in the art will realize and understand, upon reading this description, that any number of bits can be used, as long as bandwidth overlap is taken into consideration. Any bottleneck in the switching speed of these bits would most likely come from the beam velocity and steering deflector switching times.

The resonant structures in the transmitter can be manufactured in accordance with any of U.S. application Ser. Nos. 10/917,511; 11/350,812; or 11/203,407 (each of which is identified more particularly above) or in other ways.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A method comprising:
for each desired wavelength of a plurality of desired output wavelengths, selecting a light-emitting resonant structure (LERS) that emits light at the desired wavelength when exposed to a beam of charged particles; and
forming a periodically complex resonant structure from the selected light-emitting resonant structures.

2. A method as in claim 1 further comprising:
determining at least some dimensions of each said light-emitting resonant structure based, at least in part, on one or more of the following:
a voltage of said beam of charged particles;
an expected angle of observation;
a period length of the LERS; and
a velocity of the beam of charged particles.

3. A method as in claim 1 wherein there are n desired wavelengths, denoted λᵢ for integer values of i from 1 to n, and wherein there are n corresponding light-emitting resonant structures, denoted LERSᵢ for integer values of i from 1 to n, and wherein each said LERSᵢ, emits light at the wavelength λᵢ, as given by the equation:
$${λ}_{i} = \frac{{l}_{i}}{\vert {n}_{i} \vert} [ \frac{1}{β} - sin {θ}_{i} ]$$
where:
nᵢ=mode number for i-th LERS
θᵢ is angle of observation for the i-th LERS;
lᵢ is the period length for the i-th LERS.
Pᵢ is the number of periods for the i-th LERS.

4. A method comprising:
selecting a type of light made up of light of a plurality of wavelengths;
selecting a subset of said plurality of wavelengths;
for each desired wavelength of said subset of wavelengths, selecting a light-emitting resonant structure (LERS) that emits light at the desired wavelength when exposed to a beam of charged particles; and
forming a periodically complex resonant structure from the selected light-emitting resonant structures.

5. A device comprising:
a plurality of light-emitting resonant structures (LERSs), each said LERS emitting light when exposed to a common beam of charged particles, each said LERS emitting light at a wavelength distinct from at least one other said LERS.
